(19) United States
(12) Patent Application Publication
(10) Pub. No.: US 2018/0336645 A1
(43) Pub. Date: Nov. 22, 2018

(54) USING MACHINE LEARNING TO RECOMMEND LIVE-STREAM CONTENT

(71) Applicant: Google Inc., Mountain View, CA (US)

(72) Inventor: Thomas Price, San Francisco, CA (US)

(21) Appl. No.: 15/601,081

(22) Filed: May 22, 2017

(51) Int. Cl. G06Q 50/00; G06Q 30/06; H04L 12/58; G06F 17/30; G06Q 30/02; G06N 99/00

(52) U.S. Cl. CPC G06Q 50/01; G06Q 30/0631; H04L 51/10; G06F 3/0482; G06F 17/30867; G06Q 30/02; G06N 99/005; H04L 51/32

(57) ABSTRACT

A system and method are disclosed for training a machine learning model to recommend live-stream media item to a user of content sharing platform. In an implementation, training data for the machine learning model is generated by generating first training input that includes one or more previously presented live-stream media items that were consumed by users of first user clusters. Training data also includes generating second training input that includes one or more currently presented live-stream media items that are currently being consumed by users of second user clusters. Training data further includes generating a first target output that identifies the live-stream media item and a level of confidence the user is to consume the live-stream media item. The method includes providing the training data to train the machine learning model.

### TECHNICAL FIELD

Aspects and implementations of the present disclosure relate to content sharing platforms, and more specifically, to generating recommendations for live-stream media items.

### BACKGROUND

Social networks connecting via the Internet allow users to connect to and share information with each other. Many social networks include a content sharing aspect that allows users to upload, view, and share content, such as video items, image items, audio items, and so on. Other users of the social network may comment on the shared content, discover new content, locate updates, share content, and otherwise interact with the provided content. The shared content may include content from professional content creators, e.g., movie clips, TV clips, and music video items, as well as content from amateur content creators, e.g., video blogging and short original video items.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In one implementation, the method includes generating training data for a machine learning model. Generating training data for the machine learning model includes generating first training input that includes one or more previously presented live-stream media items that were consumed by users of a first plurality of user clusters on a content sharing platform. Generating training data for the machine learning model also includes generating second training input that includes currently presented live-stream media items that are currently being consumed by users of a second plurality of user clusters on the content sharing platform. The method includes generating a first target output for the first training input and the second training input. The first target output identifies a live-stream media item and a level of confidence the user is to consume the live-stream media item. The method also includes providing the training data to train the machine learning model on (i) a set of training inputs including the first training input and the second training input, and (ii) a set of target outputs in including the first target output.

In another implementation, generating the training data for the machine learning model also includes generating third training input that includes first contextual information associated with user accesses by the users of the first plurality of user clusters that consumed the one or more previously presented live-stream media items on the content sharing platform. Generating the training data for the machine learning model also includes generating fourth training input that includes generating second contextual information associated with user accesses by the users of the second plurality of user clusters that are consuming the currently presented live-stream media items on the content sharing platform. The method includes providing the training data to train the machine learning model on (i) the set of training inputs including the first, the second, the third, and the fourth training input, and (ii) the set of target outputs comprising the first target output.

In an implementation, generating training data for the machine learning model includes generating fifth training input that includes first user information associated with the users of the first plurality of user clusters that consumed the one or more previously presented live-stream media items on the content sharing platform. Generating training data for the machine learning model includes generating sixth training input that includes second user information associated with the users of the second plurality of user clusters that are consuming the currently presented live-stream media items on the content sharing platform. The method also includes providing the training data to train the machine learning model on (i) the set of training inputs including the first, the second, the fifth, and the sixth training input, and (ii) the set of target outputs including the first target output.

In one implementation, the method maps each training input of the set of training inputs to the target output in the set of target outputs.

In an implementation, the first training input includes a first user cluster of the first plurality of user clusters that consumed a first previously presented live-stream media item of the one or more previously presented live-stream media items, where the first previously presented live-stream media item was live streamed to the first user cluster.

In an implementation, the first training input includes a second user cluster of the first plurality of user clusters that consumed a second previously presented live-stream media item of the one or more previously presented live-stream media items, where the second previously presented live-stream media item was presented to the second user cluster subsequent to being live streamed.

In an implementation, the first training input includes a third user cluster of the first plurality of user clusters that consumed different previously presented live-stream media items of the one or more previously presented live-stream media items, where the different previously presented live-stream media items were live streamed to the third user cluster and were subsequently classified in a similar category of live-stream media items.

In an implementation, the method also receives an indication of a user access by the user to the content sharing platform. The method generates, by the machine learning model, a test output that identifies a test live-stream media item and a level of confidence the user is to consume the test live-stream media item. The method further provides a recommendation of the test live-stream media item to the user. The method receives an indication of consumption of the test live-stream media item by the user in view of the recommendation. Responsive to the indication of consumption of the test live-stream media item by the user, the method adjusts the machine learning model based on the indication of consumption.

In an implementation, the machine learning model is configured to process a new user access by a new user to the content sharing platform and generate one or more outputs indicating (i) a current live-stream media item, and (ii) a level of confidence the new user is to consume the current live-stream media item.

In a different implementation, a method to recommend a live-stream media item is disclosed. The method includes receiving an indication of a user access by a user to a content sharing platform. Responsive to the user access, the method provides to a trained machine learning model first input that includes contextual associated with the user access to the content sharing platform, second input that includes user information associated with the user access to the content sharing platform, and third input that includes live-stream media items that are live-streamed concurrent with the user access and that are currently being consumed by users of a first plurality of user clusters on the content sharing platform. The method also obtains, from the trained machine learning model, one or more outputs identifying (i) a plurality of live-stream media items and (ii) a level of confidence the user is to consume a respective live-stream media item of the plurality of live-stream media items.

In another implementation, the method provides a recommendation for one or more of the plurality of live-stream media items to the user of the content sharing platform in view of the level of confidence the user is to consume the respective live-stream media item of the plurality of live-stream media items.

In one implementation, in providing the recommendation for the one or more of the plurality of live-stream media items to the user of the content sharing platform, the method determines whether the level of confidence associated with each the plurality of live-stream media items exceeds a threshold level. Responsive to determining that the level of confidence associated with the one or more of the plurality of live-stream media items exceeds the threshold level, the method provides the recommendation for each of the one or more of the plurality of live-stream media items to the user.

In an implementation, the trained machine learning model has been trained using a first training input including one or more previously presented live-stream media items that were consumed by users of a second plurality of user clusters on the content sharing platform.

In an implementation, the first training input includes a first user cluster of the second plurality of user clusters that consumed a first previously presented live-stream media item that was live streamed to users of the first user cluster.

In an implementation, the first training input includes a second user cluster of the second plurality of user clusters that consumed a second previously presented live-stream media item that was presented to users of the second user cluster subsequent to being live streamed.

In an implementation, the first training input includes a third user cluster of the second plurality of user clusters that consumed different previously presented live-stream media items that were live streamed to users of the third user cluster and were subsequently classified in a similar category of live-stream media items.

In an implementation, the live-stream media item is a live-stream video item.

In additional implementations, one or more processing devices for performing the operations of the above described implementations are disclosed. Additionally, in implementations of the disclosure, a non-transitory computer-readable storage medium stores instructions for performing the operations of the described implementations. Also in other implementations, systems for performing the operations of the described implementations are also disclosed.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding.

FIG. 1 illustrates an example system architecture, in accordance with one implementation of the present disclosure.

FIG. 2 is an example training set generator to create training data for a machine learning model that recommends live-stream media items, in accordance with implementations of the present disclosure.

FIG. 3 depicts a flow diagram of one example of a method for training a machine learning model to recommend live-stream video items, in accordance with implementations of the present disclosure.

FIG. 4 depicts a flow diagram of one example of a method for using the trained machine learning model to recommend live-stream video items, in accordance with implementations of the present disclosure.

FIG. 5 is a block diagram illustrating an exemplary computer system 500, in accordance with an implementation of the present disclosure.

### DETAILED DESCRIPTION

A media item, such as a video item (also referred to as “a video”) may be uploaded to a content sharing platform by a video owner (e.g., a video creator or a video publisher who is authorized to upload the video item on behalf of the video creator) for transmission as a live-stream of an event for consumption by users of the content sharing platform via their user devices. A live-stream media item may refer to a live broadcast or transmission of a live event, where the media item is concurrently transmitted, at least in part, as the event occurs, and where the media item is not available in its entirety. Often archived media items, such as pre-recorded movies, are previously recorded and stored, which presents sufficient time to analyze the contents of the archived media item. For example, an archived media item may be classified by a human classifier or machine-aided classifier to generate metadata descriptive of the contents of the archived media item. Live-stream media items are broadcasts of live events, and offer incomplete information (e.g., the complete data of the live-stream has not been received) or insufficient time (or otherwise) to perform robust content analysis. As compared to classified archived media items, little to no information may be known about the contents of live-stream media items. The aforementioned characteristics present challenges, such as identifying relevant live-stream media items for recommendation to users of a content sharing platform and providing sufficient computational resources to identify relevant live-stream media items.

Aspects of the present disclosure address the above-mentioned and other challenges by training a machine learning model using training data that includes previously presented live-stream media items and currently presented live-stream media items. The previously presented live-stream media items are live-stream media items that were consumed by users of a first plurality of user clusters on a content sharing platform in the past. The currently presented live-stream media items are live-stream media items that are currently being consumed by users of a second plurality of user clusters on the content sharing platform. A user cluster may be a grouping of users, such as users of a content sharing platform, based on one or more attributes or features, such as the previously presented live-stream media items the users consumed or currently presented live-stream media items the users are consuming. In implementations, the trained machine learning model may be used to recommend one or more live-stream media items to a specific user accessing the content sharing platform.

Training a machine learning model and using the trained machine learning model to recommend live-stream media items that are relevant to a specific user improves the overall user experience with the content sharing platform, and increases the number of live-stream media items and other media items consumed by the users of the content sharing platform. In addition, aspects of the present disclosure result in a reduction of computational (processing) resources because recommending relevant live-stream media item is more efficient than recommending non-relevant media items or performing searches for media items where little information is known about their contents.

It may be noted that live-stream media items are used for purposes of illustration, rather than limitation. In other implementations, aspects of the present disclosure may be applied to different media items, such as media items where little to no information is known about the contents of the media item. For example, aspects of the present disclosure may be applied to new media items or media items where the contents are difficult to classify, such as virtual reality media items, augmented reality media items, or three-dimensional media items.

As noted above, a live-stream media item may be a live broadcast or transmission of a live event. It may be further noted that “live-stream media item” or “currently presented live-stream media item” refers to a media item that is being live streamed (e.g., the media item is concurrently transmitted as the event occurs), unless otherwise noted. Subsequent to the completion of a live stream of a live-stream media item, the complete live-stream media item may be obtain and stored, and may be referred to as a “previously presented live-stream media item” or “archived live-stream media item” herein.

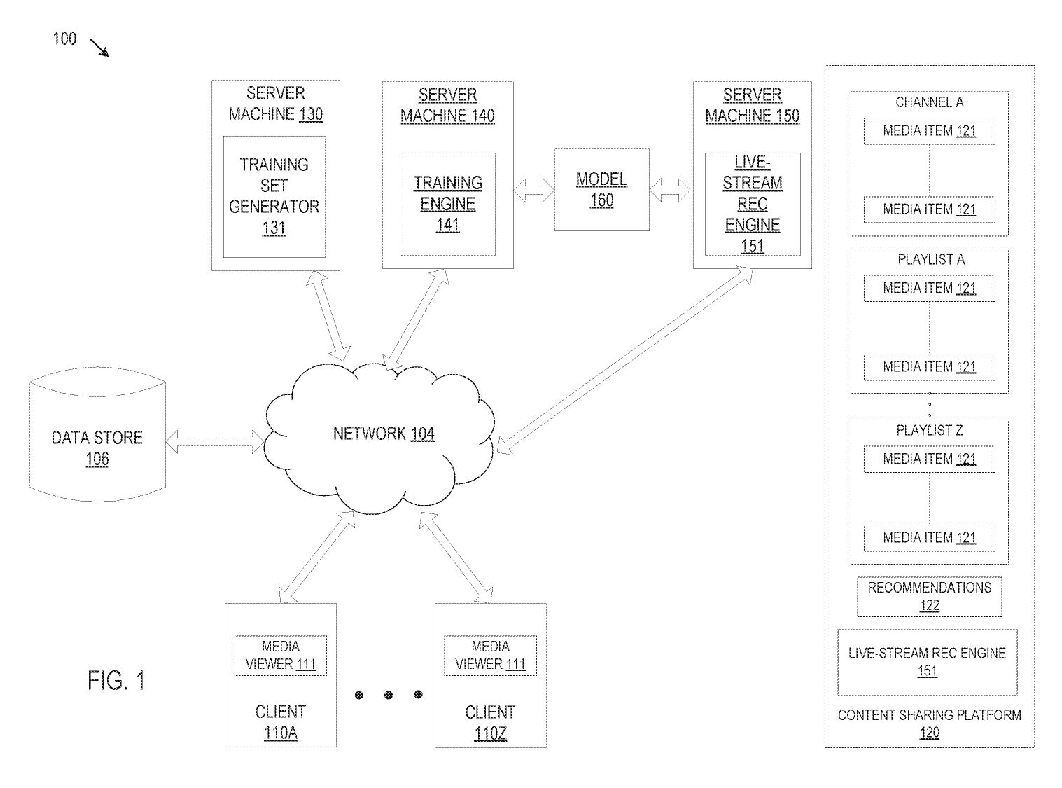

FIG. 1 illustrates an example system architecture 100, in accordance with one implementation of the present disclosure. The system architecture 100 (also referred to as “system” herein) includes a content sharing platform 120, one or more server machines 130 through 150, a data store 106, and client devices 110A-110Z connected to a network 104.

In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In implementations, data store 106 is a persistent storage that is capable of storing content items (such as media items) as well as data structures to tag, organize, and index the content items. Data store 106 may be hosted by one or more storage devices, such as main memory, magnetic or optical storage based disks, tapes or hard drives, NAS, SAN, and so forth. In some implementations, data store 106 may be a network-attached file server, while in other embodiments data store 106 may be some other type of persistent storage such as an object-oriented database, a relational database, and so forth, that may be hosted by content sharing platform 120 or one or more different machines coupled to the server content sharing platform 120 via the network 104.

The client devices 110A-110Z may each include computing devices such as personal computers (PCs), laptops, mobile phones, smart phones, tablet computers, netbook computers, network-connected televisions, etc. In some implementations, client devices 110A through 110Z may also be referred to as “user devices.” In implementations, each client device includes a media viewer 111. In one implementation, the media viewers 111 may be applications that allow users to view or upload content, such as images, video items, web pages, documents, etc. For example, the media viewer 111 may be a web browser that can access, retrieve, present, and/or navigate content (e.g., web pages such as Hyper Text Markup Language (HTML) pages, digital media items, etc.) served by a web server. The media viewer 111 may render, display, and/or present the content (e.g., a web page, a media viewer) to a user. The media viewer 111 may also include an embedded media player (e.g., a Flash® player or an HTML5 player) that is embedded in a web page (e.g., a web page that may provide information about a product sold by an online merchant). In another example, the media viewer 111 may be a standalone application (e.g., a mobile application or app) that allows users to view digital media items (e.g., digital video items, digital images, electronic books, etc.). According to aspects of the disclosure, the media viewer 111 may be a content sharing platform application for users to record, edit, and/or upload content for sharing on the content sharing platform. As such, the media viewers 111 may be provided to the client devices 110A-110Z by the server machine 150 or content sharing platform 120. For example, the media viewers 111 may be embedded media players that are embedded in web pages provided by the content sharing platform 120. In another example, the media viewers 111 may be applications that are downloaded from the server machine 150.

In one implementation, the content sharing platform 120 or server machines 130-150 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to media items and/or provide the media items to the user. For example, the content sharing platform 120 may allow a user to consume, upload, search for, approve of (“like”), disapprove of (“dislike”), or comment on media items. The content sharing platform 120 may also include a website (e.g., a webpage) or application back-end software that may be used to provide a user with access to the media items.

In implementations of the disclosure, a “user” may be represented as a single individual. However, other implementations of the disclosure encompass a “user” being an entity controlled by a set of users and/or an automated source. For example, a set of individual users federated as a community in a social network may be considered a “user”. In another example, an automated consumer may be an automated ingestion pipeline, such as a topic channel, of the content sharing platform 120.

The content sharing platform 120 may include multiple channels (e.g., channels A through Z). A channel can be data content available from a common source or data content having a common topic, theme, or substance. The data content can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking”, “following”, “friending”, and so on.

Once a user subscribes to a channel, the user can be presented with information from the channel's activity feed. If a user subscribes to multiple channels, the activity feed for each channel to which the user is subscribed can be combined into a syndicated activity feed. Information from the syndicated activity feed can be presented to the user. Channels may have their own feeds. For example, when navigating to a home page of a channel on the content sharing platform, feed items produced by that channel may be shown on the channel home page. Users may have a syndicated feed, which is a feed including at least a subset of the content items from all of the channels to which the user is subscribed. Syndicated feeds may also include content items from channels that the user is not subscribed. For example, the content sharing platform 120 or other social networks may insert recommended content items into the user's syndicated feed, or may insert content items associated with a related connection of the user in the syndicated feed.

Each channel may include one or more media items 121. Examples of a media item 121 can include, and are not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In some implementations, media item 121 is also referred to as content or a content item.

A media item 121 may be consumed via the Internet or via a mobile device application. For brevity and simplicity, a video item is used as an example of a media item 121 throughout this document. As used herein, “media,” media item,” “online media item,” “digital media,” “digital media item,” “content,” and “content item” can include an electronic file that can be executed or loaded using software, firmware or hardware configured to present the digital media item to an entity. In one implementation, the content sharing platform 120 may store the media items 121 using the data store 106. In another implementation, the content sharing platform 120 may store video items or fingerprints as electronic files in one or more formats using data store 106.

In one implementation, the media items 121 are video items. A video item is a set of sequential video frames (e.g., image frames) representing a scene in motion. For example, a series of sequential video frames may be captured continuously or later reconstructed to produce animation. Video items may be presented in various formats including, but not limited to, analog, digital, two-dimensional and three-dimensional video. Further, video items may include movies, video clips or any set of animated images to be displayed in sequence. In addition, a video item may be stored as a video file that includes a video component and an audio component. The video component may refer to video data in a video coding format or image coding format (e.g., H.264 (MPEG-4 AVC), H.264 MPEG-4 Part 2, Graphic Interchange Format (GIF), WebP, etc.). The audio component may refer to audio data in an audio coding format (e.g., advanced audio coding (AAC), MP3, etc.). It may be noted GIF may be saved as an image file (e.g., .gif file) or saved as a series of images into an animated GIF (e.g., GIF89a format). It may be noted that H.264 may be a video coding format that is block-oriented motion-compensation-based video compression standard for recording, compression, or distribution of video content, for example.

In implementations, content sharing platform 120 may allow users to create, share, view or use playlists containing media items (e.g., playlist A-Z, containing media items 121). A playlist refers to a collection of media items that are configured to play one after another in a particular order without any user interaction. In implementations, content sharing platform 120 may maintain the playlist on behalf of a user. In implementations, the playlist feature of the content sharing platform 120 allows users to group their favorite media items together in a single location for playback. In implementations, content sharing platform 120 may send a media item on a playlist to client device 110 for playback or display. For example, the media viewer 111 may be used to play the media items on a playlist in the order in which the media items are listed on the playlist. In another example, a user may transition between media items on a playlist. In still another example, a user may wait for the next media item on the playlist to play or may select a particular media item in the playlist for playback.

In some implementations, content sharing platform 120 may make recommendations of media items, such as recommendations 122, to a user or group of users. A recommendation may be an indicator (e.g., interface component, electronic message, recommendation feed, etc.) that provides a user with personalized suggestions of media items that may appeal to a user. For example, a recommendation may be presented as a thumbnail of a media item. Responsive to interaction by the user (e.g., click), a larger version of the media item may be presented for playback. In implementations, a recommendation may be made using data from a variety of sources including a user's favorite media items, recently added playlist media items, recently watched media items, media item ratings, information from a cookie, user history, and other sources. In one implementation, a recommendation may be based on an output of a trained machine learning model 160, as will be further described herein. It may be noted that a recommendation may be for a media item 121, a channel, a playlist, among others. In one implementation, the recommendation 122 may be a recommendation for one or more a live-stream video items currently being live streamed on the content sharing platform 120.

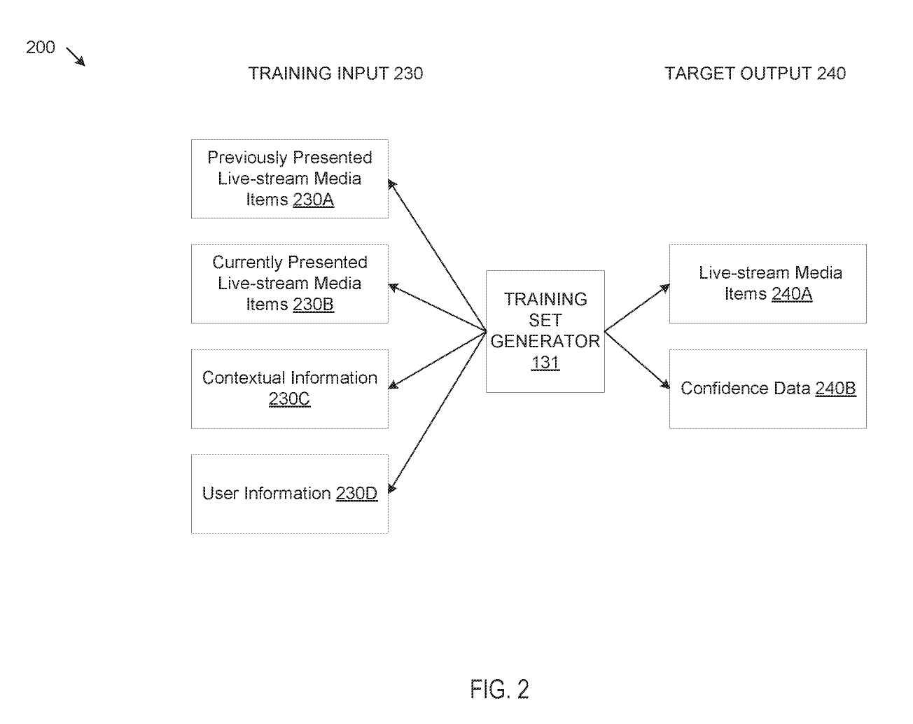

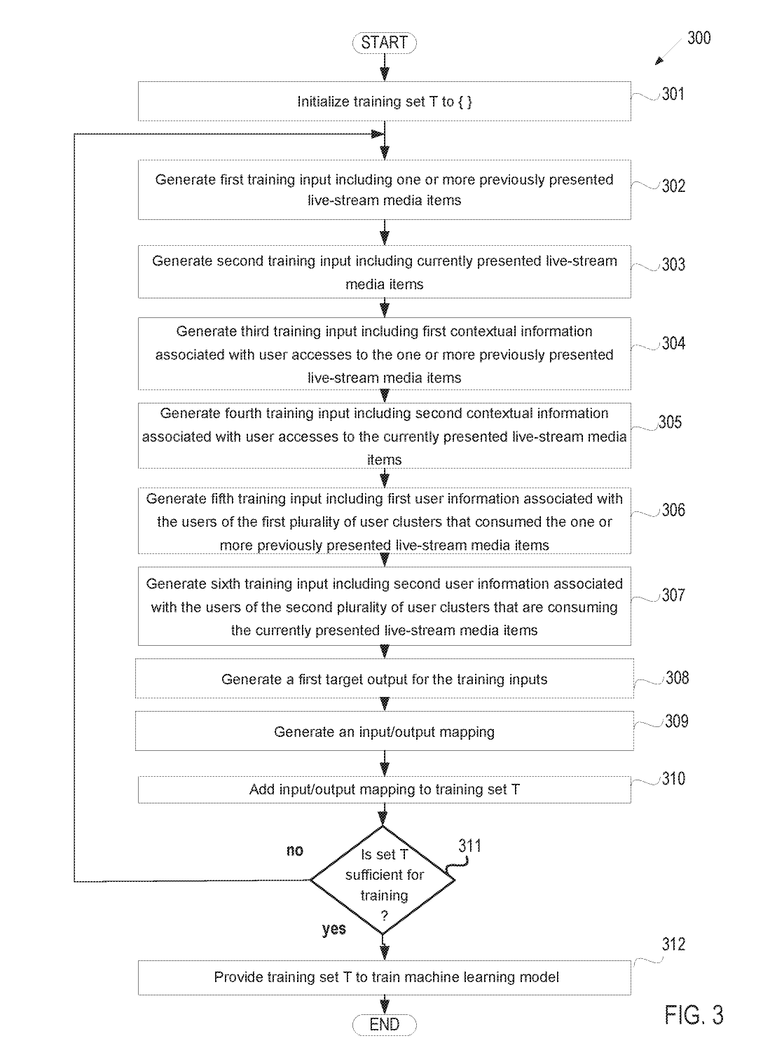

Server machine 130 includes a training set generator 131 that is capable of generating training data (e.g., a set of training inputs and a set of target outputs) to train a machine learning model. Some operations of training set generator 131 are described in detail below with respect to FIGS. 2-3.

Server machine 140 includes a training engine 141 that is capable of training a machine learning model 160 using the training data from training set generator 131. The machine learning model 160 may refer to the model artifact that is created by the training engine 141 using the training data that includes training inputs and corresponding target outputs (correct answers for respective training inputs). The training engine 141 may find patterns in the training data that map the training input to the target output (the answer to be predicted), and provide the machine learning model 160 that captures these patterns. The machine learning model 160 may be composed of, e.g., a single level of linear or non-linear operations (e.g., a support vector machine [SVM] or may be a deep network, i.e., a machine learning model that is composed of multiple levels of non-linear operations). An example of a deep network is a neural network with one or more hidden layers, and such machine learning model may be trained by, for example, adjusting weights of a neural network in accordance with a backpropagation learning algorithm or the like. For convenience, the remainder of this disclosure will refer to the implementation as a neural network, even though some implementations might employ an SVM or other type of learning machine instead of, or in addition to, a neural network. In one aspect, the training set is obtained from server machine 130.

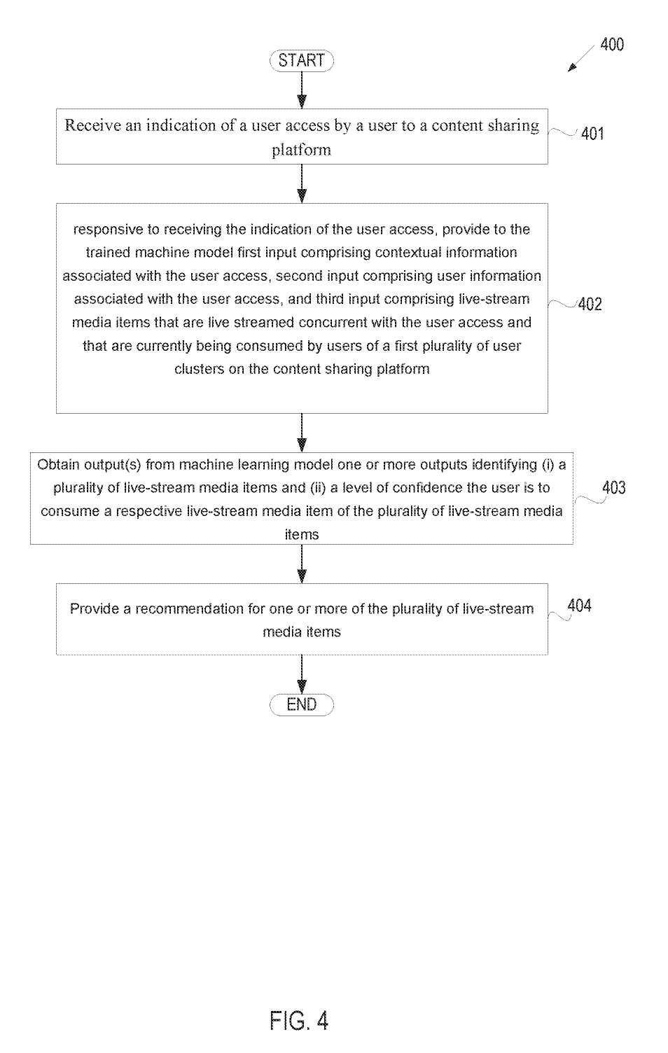

Server machine 150 includes a live-stream recommendation engine 151 that provides data (e.g., contextual information associated with a user access to the content sharing platform 120, user information associated with the user access, or live-stream media items that are live streamed concurrent with the user access and that are currently being consumed by users of one or more user clusters) as input to trained machine learning model 160 and runs trained machine learning model 160 on the input to obtain one or more outputs. As described in detail below with respect to FIG. 4, in one implementation live-stream recommendation engine 151 is also capable of identifying one or more live-stream media items that are currently or imminently being live streamed from the output of the trained machine learning model 160 and extract confidence data from the output that indicates a level of confidence a user is to consume a respective live-stream media item, and using the confidence data to provide recommendations of live-stream media items that are currently being live streamed.

It should be noted that in some other implementations, the functions of server machines 130, 140, and 150 or content sharing platform 120 may be provided by a fewer number of machines. For example, in some implementations server machines 130 and 140 may be integrated into a single machine, while in some other implementations server machines 130, 140, and 150 may be integrated into a single machine. In addition, in some implementations one or more of server machines 130, 140, and 150 may be integrated into the content sharing platform 120.

In general, functions described in one implementation as being performed by the content sharing platform 120, server machine 130, server machine 140, or server machine 150 can also be performed on the client devices 110A through 110Z in other implementations, if appropriate. In addition, the functionality attributed to a particular component can be performed by different or multiple components operating together. The content sharing platform 120, server machine 130, server machine 140, or server machine 150 can also be accessed as a service provided to other systems or devices through appropriate application programming interfaces, and thus is not limited to use in websites.

Although implementations of the disclosure are discussed in terms of content sharing platforms and promoting social network sharing of a content item on the content sharing platform, implementations may also be generally applied to any type of social network providing connections between users. Implementations of the disclosure are not limited to content sharing platforms that provide channel subscriptions to users.

In situations in which the systems discussed here collect personal information about users, or may make use of personal information, the users may be provided with an opportunity to control whether the content sharing platform 120 collects user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform 120.

FIG. 2 is an example training set generator to create training data for a machine learning model that recommends live-stream media items, in accordance with implementations of the present disclosure. System 200 shows training set generator 131, training inputs 230, and target outputs 240. System 200 may include similar components as system 100, as described with respect to FIG. 1. Components described with respect to system 100 of FIG. 1 may be used to help describe system 200 of FIG. 2.

In implementations, training set generator 131 generates training data that includes one or more training inputs 230, one or more target outputs 240. The training data may also include mapping data that maps the training inputs 230 to the target outputs 240. Training inputs 230 may also be referred to as “features” or “attributes.” In an implementation, training set generator 131 may provide the training data in a training set, and provide the training set to the training engine 141 where the training set is used to train the machine learning model 160. Generating a training set may further be described with respect to FIG. 3.

In one implementation, training inputs 230 may include one or more previously presented live-stream media items 230A, currently presented live-stream media item 230B, contextual information 230C, or user information 230D. In an implementation, previously presented live-stream media items 230A may be archived live-stream media item that were consumed by users of one or more user clusters of content sharing platform 120.

In one implementation, the previously presented live-stream media items 230A may include a previously presented live-stream media item mapped to (or associated with) a group of users (referred to as a “cluster of users”) who consumed (e.g., co-viewed) the (same) previously presented live-stream media item while the live-stream media item was live streamed to the users of the cluster of users. It may be noted that previously presented live-stream media items 230A may include multiple previously presented live-stream media items where each previously presented live-stream media item is mapped to a respective cluster of users that co-viewed the previously presented live-stream media item. It may be noted that users who watched one or more of the same live-stream media items while the media items were live streamed would cluster more closely together (than users who did not watch any of the same live-stream media items).

In implementations, users may be clustered together in view of one or more features, such as the consumption of the same previously presented live-stream media item. It may be noted that in some implementations, the cluster of users may be clustered prior to being used as a training input 230 (or prior to being used as an input to the trained machine learning model 160, as described below). For example, a (previously presented) live-stream media item that is mapped to a cluster of users may be a training input 230 where the clusters were determined prior to being used as training input 230. The aforementioned training input 230 may be a single training input and be referred to as for example, a previously presented live-stream media item mapped to a user cluster or referred to as a user cluster that consumed the previously presented live-stream media item (or similar). It may also be noted that the aforementioned training input 230 may include the particular live-stream media item and additional information identifying or specifying users of the particular cluster of users. It may be noted that in implementations where the live-stream media item mapped to a user cluster, training set generator 131 may further generate new clusters of users or refine existing clusters of users. In other implementations, the (e.g., previously presented) live-stream media item and users that consume the (previously presented) live-stream media item may be separate training inputs 230 where the training set generator 131 determines the user clusters (e.g. based on the contextual information 230C or user information 230D of users of the user clusters). It may be noted that the aforementioned may be applied to other user clusters and live-stream media items mapped to the other user clusters described herein.

In some implementations, machine learning techniques may be used to determine the user clusters that are used as training input 230 (or input to trained machine learning model 160). For example, K-means clustering or other clustering algorithms may be used.

It may be noted that additional features may be used to distinguish clusters of user that consumed previously presented live-stream media items 230, as will be described in the following.

In another implementation, the previously presented live-stream media items 230A include a previously presented live-stream media item mapped to (or associated with) a cluster of users, where the cluster of users consumed the (same) previously presented live-stream media item after the live-stream media item was live streamed (e.g., consumed an archived live-stream media item). It may be noted that previously presented live-stream media items 230A may include multiple previously presented live-stream media items where each of the previously presented live-stream media item is mapped to a respective cluster of users that co-viewed respective archived live-stream media item. It may be noted that a user that watched an archived live-stream media item and a different user that watched the same live-stream media item while the media item was live streamed would cluster closely together.

In still another implementation, the previously presented live-stream media items 230A include different previously presented live-stream media items mapped to (or associated with) a cluster of users, where the cluster of users consumed one or more of the different previously presented live-stream media items during the live stream of the different previously presented live-stream media items and the different previously presented live-stream media items were later classified in a similar or same category of live-stream media item. For example, a first group of users consumed live-stream A, and a second group of users consumed a live-stream B. Live-stream A and live-stream B were subsequently archived and categorized (e.g., human classification or machine-aided classification, such as content analysis). Live-streams A and B were both categorized as soccer matches. The user that consumed live-stream A and a different user that consumed live-stream B may be included in a same cluster of users. The aforementioned previously presented live-stream media items 230A and the respective clusters of users are intended to be illustrative, rather than limiting, as other combinations of elements presented herein or other previously presented live-stream media items 230A and associated clusters of users may also be used.

It may also be noted that content analysis may be performed on the previously presented live-stream media items 230A (e.g., complete information received), and metadata descriptive of the previously presented live-stream media items 230A may be obtained. In one implementation, the metadata may include descriptors or categories describing the content of the previously presented live-stream media items 230A. The descriptors and categories may be generated using human classification or machine-aided classification and associated with the respective previously presented live-stream media items 230A. In some implementations, the metadata of the previously presented live-stream media items 230A may be used as additional training input 230.

In one implementation, training inputs 230 may include currently presented live-stream media item 230B. In an implementation, a currently presented live-stream media item 230B may include a currently presented live-stream media item mapped to (or associated with) a cluster of users, where the users of the cluster of users are currently consuming (e.g., co-viewership) the (same) live-stream media item while the live-stream media item is being live streamed to the users of the cluster of users on the content sharing platform 120. It may be noted that currently presented live-stream media items 230B may include multiple currently presented live-stream media items where each of the currently presented live-stream media items are mapped to a respective cluster of users that are co-viewing a respective currently presented live-stream media item. In some implementations, currently presented live-stream media-items have little or no metadata describing their contents.

In implementations, training inputs 230 may include contextual information 230C. Contextual information may refer to information regarding the circumstances or context of a user access by a user to the content sharing platform 120 to consume a particular media item. For example, a user may access the content sharing platform 120 using a browser or local application. A contextual record of the user access may be recorded and stored, and include information such as time of day of the user access, Internet Protocol (IP) address assigned to the user device making the access (which may be used to determine a location of the device or user), type of user device, or other contextual information describing the user access. In implementations, contextual information 230C may include the contextual information of user accesses by the users of some or all of the user clusters to the content sharing platform 120 for the consumption of the previously presented live-stream media items 230A or the currently presented live-stream media item 230B.

In implementations, training inputs 230 may include user information 230D. User information may refer to information regarding or describing a user that accesses the content sharing platform 120. For example, user information 230D may include a user's age, gender, user history (e.g., previously watched media items), or affinities. An affinity may refer to a user's interest in a particular category (e.g., news, video game, college basketball, etc.) of media item. An affinity score (e.g. a value 0-1, low to high) may be a assigned to each category to quantify a user's interest in a particular category. For example, a user may have an affinity score of 0.5 for college basketball and an affinity score of 0.9 for video gaming. For example, a user may be logged in (e.g., account name and password) to the content sharing platform 120, and the user information 230D may be associated with the user account. In another example, a cookie may be associated with a user, user device, or user application, and the user information 230D may be determined from the cookie. In implementations, user information 230D may include the user information of some or all the users of some or all of the user clusters that consume the previously presented live-stream media items 230A or the currently presented live-stream media item 230B.

In implementations, target outputs 240 may include one or more live-stream media items 240A. In an implementation, the live-stream media item 240A may include a currently presented live-stream media item. In an implementation, the live-stream media item 240A may include associated confidence data 240B. Confidence data 240B may include or indicate a level of confidence that a user is to consume a live-stream media item 240A. In one example, the level of confidence is a real number between 0 and 1 inclusive, where 0 indicates no confidence a user will consume live-stream media item 240A and 1 indicates absolute confidence a user will consume live-stream media item 240A.

In some implementations, subsequent to generating a training set and training machine learning model 160 using the training set, the machine learning model 160 may be further trained (e.g., additional data for a training set) or adjusted (e.g., adjusting weights associated with input data of the machine learning model 160, such as connection weights in a neural network) using a recommended live-stream media item (e.g., recommended using the trained or partially-trained machine learning model 160) and user interaction with the recommended live-stream media item. For example, after a training set is generated and machine learning model 160 is trained using the training set, the machine learning model 160 may be used to make a recommendation of a live-stream media item to a user of the content sharing platform 120. Subsequent to making the recommendation, the system 100 may receive an indication of consumption by the user of the recommended live-stream media item. For instance, the system 100 may receive an indication that the user consumed the recommended live-stream media item (e.g., watched the live-stream video item for a threshold amount of time) or an indication the user did not consume the recommended live-stream media item (e.g., did not select the recommended live-stream media item). Information regarding the recommended live-stream media item may be used as additional training inputs 230 or additional target outputs 240 to further train or adjust machine learning model 160. For example, contextual information of the user access and user information of the user associated with the recommended live-stream media item may be used as additional training inputs 230, and the recommended live-stream media item may be used as a target output 240. In still other examples, the indication of user consumption may be used to generate or adjust confidence data for the recommend live-stream media item, and the confidence data may be used to an additional target output 240.

In one implementation, to further train or adjust the machine learning model 160 using a recommended live-stream media item, system 100 may receive an indication of a user access by the user to the content sharing platform 120. System 100 uses the (trained or partially-trained) machine learning model 160 to generate a test output that identifies a test live-stream media item and a level of confidence the user will consume the test live-stream media item. System 100 provides a recommendation of the test live-stream media item to the user based on the level of confidence (e.g., if the level of confidence exceeds a threshold). System 100 receives an indication of consumption of the test live-stream media item by the user in view of the recommendation. The system 100 responsive to the indication of consumption of the test live-stream media item by the user, adjusts the machine learning model based on the indication of consumption.

FIG. 3 depicts a flow diagram of one example of a method 300 for training a machine learning model, in accordance with implementations of the present disclosure. The method is performed by processing logic that may include hardware (circuitry, dedicated logic, etc.), software (e.g., instructions run on a processing device), or a combination thereof. In one implementation, the some or all the operations of method 300 may be performed by one or more components of system 100 of FIG. 1. In other implementations, one or more operations of method 300 may be performed by training set generator 131 of server machine 130 as described with respect to FIGS. 1-2. It may be noted that components described with respect FIGS. 1-2 may be used to illustrate aspects of FIG. 3.

Method 300 begins with generating training data for a machine learning model. In some implementations, at block 301 processing logic implementing method 300 initializes a training set T to an empty set. At block 302, processing logic generates first training input that includes one or more previously presented live-stream media items 230A (as described with respect to FIG. 2) that were consumed by users of a first plurality of user clusters on a content sharing platform. At block 303, processing logic generates second training input including currently presented live-stream media items 230B that are currently being consumed by users of a second plurality of user clusters on the content sharing platform. At block 304, processing logic generates third training input that includes first contextual information associated with user accesses by the users of the first plurality of user clusters that consumed the one or more previously presented live-stream media items 230A on the content sharing platform 120. At block 305, processing logic generates fourth training input that includes second contextual information associated with user accesses by the users of the second plurality of user clusters that are consuming the currently presented live-stream media items on the content sharing platform. At block 306, processing logic generates fifth training input that includes first user information associated with the users of the first plurality of user clusters that consumed the one or more previously presented live-stream media items 230A on the content sharing platform 120. At block 307, processing logic generates sixth training input that includes second user information associated with the users of the second plurality of user clusters that are consuming the currently presented live-stream media items 230B on the content sharing platform 120.

At block 308, processing logic generates a first target output for one or more of the training inputs (e.g., training inputs one through six). The first target output identifies a live-stream media item (e.g., currently presented) and a level of confidence the user is to consume the live-stream media item. At block 309, processing logic generates mapping data that is indicative of an input/output mapping. The input/output mapping (or mapping data) may refer to the training input (e.g., one or more of the training inputs described herein), the target output for the training input (e.g., where the target output identifies a live-stream media item and a level of confidence a user will consume the live-stream media item), and where the training input(s) is associated with (or mapped to) the target output. At block 310, processing logic adds the mapping data generated at block 309 to training set T.

At block 311, processing logic branches based on whether training set T is sufficient for training machine learning model 160. If so, execution proceeds to block 312, otherwise, execution continues back at block 302. It should be noted that in some implementations, the sufficiency of training set T may be determined based simply on the number of input/output mappings in the training set, while in some other implementations, the sufficiency of training set T may be determined based on one or more other criteria (e.g., a measure of diversity of the training examples, accuracy, etc.) in addition to, or instead of, the number of input/output mappings.

At block 312, processing logic provides training set T to train machine learning model 160. In one implementation, training set T is provided to training engine 141 of server machine 140 to perform the training. In the case of a neural network, for example, input values of a given input/output mapping (e.g., numerical values associated with training inputs 230) are input to the neural network, and output values (e.g., numerical values associated with target outputs 240) of the input/output mapping are stored in the output nodes of the neural network. The connection weights in the neural network are then adjusted in accordance with a learning algorithm (e.g., backpropagation, etc.), and the procedure is repeated for the other input/output mappings in training set T. After block 312, machine learning model 160 can be trained using training engine 141 of server machine 140. The trained machine learning model 160 may be implemented by live-stream recommendation engine 151 (of server machine 150 or content sharing platform 120) to determine live-stream media items and confidence data for each of the live-stream media items and to make recommendations of live-stream media item to users.

FIG. 4 depicts a flow diagram of one example of a method 400 for using the trained a machine learning model to recommend live-stream video items, in accordance with implementations of the present disclosure. The method is performed by processing logic that may include hardware (circuitry, dedicated logic, etc.), software (e.g., instructions run on a processing device), or a combination thereof. In one implementation, some or all the operations of method 400 may be performed by one or more components of system 100 of FIG. 1. In other implementations, one or more operations of method 400 may be performed by live-stream recommendation engine 151 of server machine 150 or content sharing platform 120 implementing a trained model, such as trained machine learning model 160 as described with respect to FIGS. 1-3. It may be noted that components described with respect FIGS. 1-2 may be used to illustrate aspects of FIG. 4.

In some implementations, the trained machine learning model 160 may be used to recommend a currently presented live-stream media item that is being live streamed on the content sharing platform 120. In some implementations, responsive to a user accessing (e.g., access user) the content sharing platform 120, multiple inputs may be provided to the trained machine learning model 160. For example, the inputs may include the currently presented live-stream media items (at the time of the user access) mapped to the users or user clusters currently consuming the currently presented live-stream media items. The inputs may also include information about the user accessing the content sharing platform 120, such as user information 230D, or contextual data, such as contextual information 230C regarding the user access. The trained machine learning model 160 may graph or map the access user in a multi-dimensional space (e.g., where each dimension is based on a feature of the training inputs 230). The multi-dimensional space may map other users in clusters based on the clusters used as training inputs 230 or other clusters determined by the mapping data. The access user may be mapped in one or more user clusters in the multi-dimensional space. In some implementations, the access user may be considered a cluster centroid. The trained machine learning model 160 may identify other users or user clusters that are proximate (e.g., proximate users or user clusters) the access user (e.g., some threshold distance), examine the currently presented live-stream media items the proximate users or user clusters are accessing, and output one or more currently presented live-stream media items that the proximate users or user clusters are consuming. In some implementations, the closer the distance the proximate users or user clusters are to the access user, the higher the level of confidence the access user will consume the currently presented live-stream media item associated with a respective proximate user or user cluster.

Method 400 may begin at block 401 where processing logic implementing method 400 receives an indication of a user access by a user of a content sharing platform 120. At block 402, responsive to the user access, processing logic provides, to a trained machine learning model 160, input data having first input, second input and third input. First input includes contextual information (e.g., contextual information 230C) associated with the user access to the content sharing platform 120. For example, the contextual information may include the time of day of the user access and type of device accessing the content sharing platform 120. Second input includes user information (e.g., user information 230D) associated with the user access to the content sharing platform 120. For example, the user information may include gender and age of the user. Third input includes live-stream media items that are live streamed concurrent with the user access and that are currently being consumed by users of a first plurality of user clusters on the content sharing platform 120. For example, the third input may include a currently presented live-stream media item that is being live streamed on the content sharing platform 120 and that is mapped to or associated with a cluster of users consuming the currently presented live-stream media item. In implementations, the inputs (e.g., first through third inputs) may be provided to the trained machine learning model 160 in a single operation or multiple operations.

At block 403, processing logic obtains, from the trained machine learning model 160 and based on the input data, one or more outputs identifying (i) a plurality of live-stream media items and (ii) a level of confidence the user is to consume a respective live-stream media item of the plurality of live-stream media items. For example, the trained machine learning model 160 may output a live-stream media item that is currently being live-streamed on content sharing platform 120 and confidence data indicating a level of confidence that the user that is accessing the content sharing platform 120 will consume the currently presented live-stream media item.

At block 404, processing logic may provide a recommendation for one or more of the plurality of live-stream media items to the user of the content sharing platform 120 in view of the level of confidence that the user is to consume the respective live-stream media item of the plurality of live-stream media items. In one implementation, processing logic may determine which of the plurality of live-stream media items determined by the trained machine learning model 160 have levels of confidence that exceed or meet a threshold level. Processing logic may select some (e.g., top three) or all of the live-stream media items (a group of live-stream media items) that have levels of confidence that exceed or meet the threshold level and provide a recommendation for each live-stream media item of the group of live-stream media items.

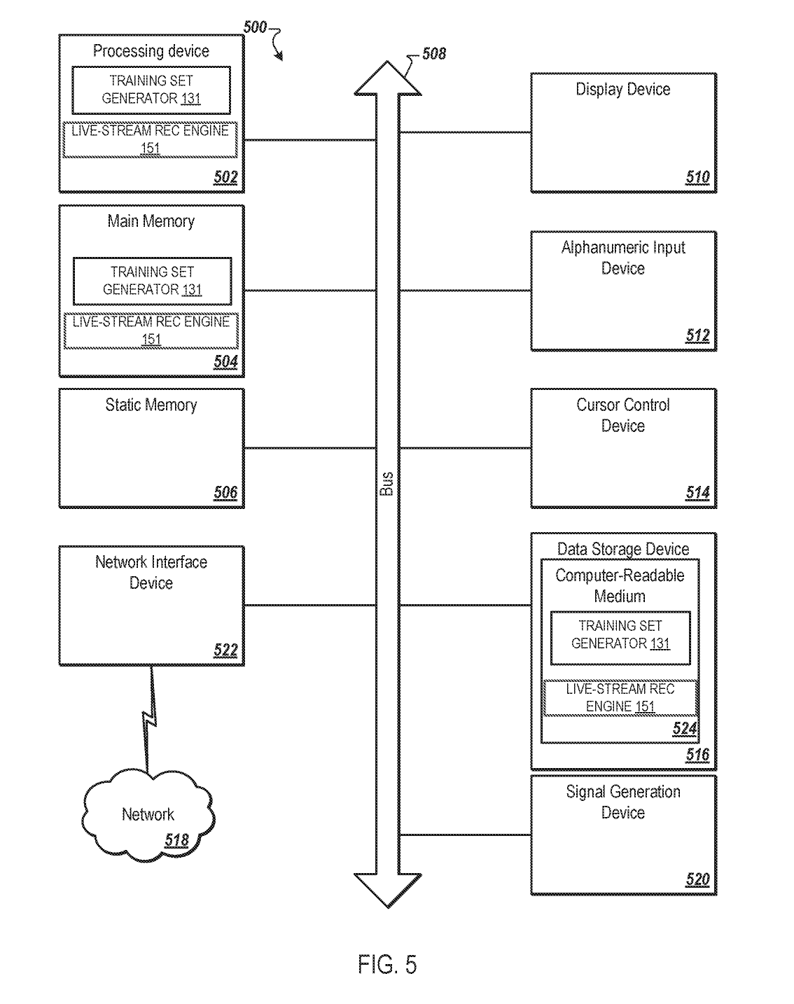

FIG. 5 is a block diagram illustrating an exemplary computer system 500, in accordance with an implementation of the present disclosure. The computer system 500 executes one or more sets of instructions that cause the machine to perform any one or more of the methodologies discussed herein. Set of instructions, instructions, and the like may refer to instructions that, when executed computer system 500, cause computer system 500 to perform one or more operations of training set generator 131 or live-stream recommendation engine 151. The machine may operate in the capacity of a server or a client device in client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 516, which communicate with each other via a bus 508.

The processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions of the system architecture 100 and the training set generator 131 or live-stream recommendation engine 151 for performing the operations discussed herein.

The computer system 500 may further include a network interface device 522 that provides communication with other machines over a network 518, such as a local area network (LAN), an intranet, an extranet, or the Internet. The computer system 500 also may include a display device 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a non-transitory computer-readable storage medium 524 on which is stored the sets of instructions of the system architecture 100 and of training set generator 131 or of live-stream recommendation engine 151 embodying any one or more of the methodologies or functions described herein. The sets of instructions of the system architecture 100 and of training set generator 131 or of live-stream recommendation engine 151 may also reside, completely or at least partially, within the main memory 504 and/or within the processing device 502 during execution thereof by the computer system 500, the main memory 504 and the processing device 502 also constituting computer-readable storage media. The sets of instructions may further be transmitted or received over the network 518 via the network interface device 522.

While the example of the computer-readable storage medium 524 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that cause the machine to perform any one or more of the methodologies of the present disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “providing”, “receiving”, “adjusting”, “generating”, “obtaining”, “determining”, or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

It is to be understood that the above description is intended to be illustrative, and not restrictive. Other implementations will be apparent to those of skill in the art upon reading and understanding the above description. The scope of the disclosure may, therefore, be determined with reference to the appended claims, along with the full scope of equivalents to which such claims are entitled.

What is claimed is:

1. A method for training a machine learning model to recommend a live-stream media item to a user, the method comprising:
generating training data for the machine learning model, wherein generating the training data comprises:
generating first training input, the first training input comprising one or more previously presented live-stream media items that were consumed by users of a first plurality of user clusters on a content sharing platform;
generating second training input, the second training input comprising one or more currently presented live-stream media items that are currently being consumed by users of a second plurality of user clusters on the content sharing platform; and
generating a first target output for the first training input and the second training input, wherein the first target output identifies the live-stream media item and a level of confidence the user is to consume the live-stream media item; and
providing the training data to train the machine learning model on (i) a set of training inputs comprising the first training input and the second training input, and (ii) a set of target outputs comprising the first target output.

2. The method of claim 1,
wherein generating the training data further comprises:
generating third training input, the third training input comprising first contextual information associated with user accesses by the users of the first plurality of user clusters that consumed the one or more previously presented live-stream media items on the content sharing platform; and
generating fourth training input, the fourth training input comprising second contextual information associated with user accesses by the users of the second plurality of user clusters to that are consuming the one or more currently presented live-stream media items on the content sharing platform; and
wherein the set of training inputs comprises the first, the second, the third, and the fourth training input.

3. The method of claim 1,
wherein generating the training data further comprises:
generating fifth training input, the fifth training input comprising first user information associated with the users of the first plurality of user clusters that consumed the one or more previously presented live-stream media items on the content sharing platform; and
generating sixth training input, the sixth training input comprising second user information associated with the users of the second plurality of user clusters that are consuming the one or more currently presented live-stream media items on the content sharing platform; and
wherein the set of training inputs comprises the first, the second, the fifth, and the sixth training input.

4. The method of claim 1, wherein each training input of the set of training inputs is mapped to the target output in the set of target outputs.

5. The method of claim 1, wherein the first training input comprises a first user cluster of the first plurality of user clusters that consumed a first previously presented live-stream media item of the one or more previously presented live-stream media items, wherein the first previously presented live-stream media item was live streamed to the first user cluster.

6. The method of claim 1, wherein the first training input comprises a second user cluster of the first plurality of user clusters that consumed a second previously presented live-stream media item of the one or more previously presented live-stream media items, wherein the second previously presented live-stream media item was presented to the second user cluster subsequent to being live streamed.

7. The method of claim 1, wherein the first training input comprises a third user cluster of the first plurality of user clusters that consumed different previously presented live-stream media items of the one or more previously presented live-stream media items, wherein the different previously presented live-stream media items were live streamed to the third user cluster and were subsequently classified in a similar category of live-stream media items.

8. The method of claim 1, further comprising:
receiving an indication of a user access by the user to the content sharing platform;
generating, by the machine learning model, a test output that identifies a test live-stream media item and a level of confidence the user is to consume the test live-stream media item;
providing a recommendation of the test live-stream media item to the user;
receiving an indication of consumption of the test live-stream media item by the user in view of the recommendation; and
responsive to the indication of consumption of the test live-stream media item by the user, adjusting the machine learning model based on the indication of consumption.

9. The method of claim 1, wherein the machine learning model is configured to process a new user access by a new user to the content sharing platform and generate one or more outputs indicating (i) a current live-stream media item, and (ii) a level of confidence the new user is to consume the current live-stream media item.

10. A method, comprising:
receiving an indication of a user access by a user to a content sharing platform;
responsive to receiving the indication of the user access,
providing to a trained machine learning model first input comprising contextual information associated with the user access to the content sharing platform, second input comprising user information associated with the user access, and third input comprising live-stream media items that are live streamed concurrent with the user access and that are currently being consumed by users of a first plurality of user clusters on the content sharing platform; and
obtaining, from the trained machine learning model, one or more outputs identifying (i) a plurality of live-stream media items and (ii) a level of confidence the user is to consume a respective live-stream media item of the plurality of live-stream media items.

11. The method of claim 10, further comprising:
providing a recommendation for one or more of the plurality of live-stream media items to the user of the content sharing platform in view of the level of confidence the user is to consume the respective live-stream media item of the plurality of live-stream media items.

12. The method of claim 11, where providing the recommendation for the one or more of the plurality of live-stream media items to the user of the content sharing platform comprises:
determining whether the level of confidence associated with each the plurality of live-stream media items exceeds a threshold level; and
responsive to determining that the level of confidence associated with the one or more of the plurality of live-stream media items exceeds the threshold level, providing the recommendation for each of the one or more of the plurality of live-stream media items to the user.

13. The method of claim 10, wherein the trained machine learning model has been trained using a first training input comprising one or more previously presented live-stream media items that were consumed by users of a second plurality of user clusters on the content sharing platform.

14. The method of claim 13, wherein the first training input identifies a first user cluster of the second plurality of user clusters that consumed a first previously presented live-stream media item that was live streamed to users of the first user cluster.

15. The method of claim 13, wherein the first training input identifies a second user cluster of the second plurality of user clusters that consumed a second previously presented live-stream media item that was presented to users of the second user cluster subsequent to being live streamed.

16. The method of claim 13, wherein the first training input identifies a third user cluster of the second plurality of user clusters that consumed different previously presented live-stream media items that were live streamed to users of the third user cluster and were subsequently classified in a similar category of live-stream media items.

17. A system comprising:
a memory; and
a processing device, coupled to the memory, to:
receive an indication of a user access by a user to a content sharing platform;
responsive to receiving the indication of the user access,
provide to a trained machine learning model first input comprising contextual information associated with the user access to the content sharing platform, second input comprising user information associated with the user access to the content sharing platform, and third input comprising live-stream media items that are live streamed concurrent with the user access and that are currently being consumed by users of a first plurality of user clusters on the content sharing platform; and
obtain, from the trained machine learning model, one or more outputs identifying a plurality of live-stream media items and a level of confidence the user is to consume a respective live-stream media item of the plurality of live-stream media items.

18. The system of claim 17, the processing device further to:
provide a recommendation for one or more of the plurality of live-stream media items to the user of the content sharing platform in view of the level of confidence that the user is to consume the respective live-stream media item of the plurality of live-stream media items.

19. A system comprising:
a memory; and
a processing device, coupled to the memory, to:
generate training data for a machine learning model, wherein to generate the training data, the processing device to:
generate first training input, the first training input comprising one or more previously presented live-stream media items that were consumed by users of a first plurality of user clusters on a content sharing platform;
generate second training input, the second training input comprising one or more currently presented live-stream media items that are currently being consumed by users of a second plurality of user clusters on the content sharing platform; and
generate a first target output for the first training input and the second training input, wherein the first target output identifies a live-stream media item and a level of confidence a user is to consume the live-stream media item; and
provide the training data to train the machine learning model on (i) a set of training inputs comprising the first training input and the second training input, and (ii) a set of target outputs comprising the first target output.

20. The system of claim 19,
wherein to generate the training data, the processing device further to:
generate third training input, the third training input comprising first contextual information associated with user accesses by the users of the first plurality of user clusters that consumed the one or more previously presented live-stream media items on the content sharing platform; and
generate fourth training input, the fourth training input comprising second contextual information associated with user accesses by the users of the second plurality of user clusters that are consuming the one or more currently presented live-stream media items on the content sharing platform; and
wherein the set of training inputs comprises the first, the second, the third, and the fourth training input.
